(19) United States
(12) Patent Application Publication
(10) Pub. No.: US 2017/0169556 A1
(43) Pub. Date: Jun. 15, 2017

(54) WORKPIECE MEASURING APPARATUS AND METHOD FOR MEASURING A WORKPIECE

(71) Applicant: INDUSTRIAL TECHNOLOGY RESEARCH INSTITUTE, Hsinchu Hsien (TW)

(72) Inventors: Yueh-Yi Lai, Hsinchu (TW); Chang-Shuo Wu, Hsinchu (TW)

(21) Appl. No.: 14/964,736

(22) Filed: Dec. 10, 2015

(51) Int. Cl. G06T 7/00; G06T 7/20; G06K 9/52; G06K 9/62; H04N 7/18; G06T 7/60

(52) U.S. Cl. CPC G06T 7/0004; H04N 7/18; G06T 7/004; G06T 7/60; G06K 9/52; G06K 9/6215; G06T 7/20; G06T 2207/30164

(57) ABSTRACT

A workpiece measuring apparatus and a method for measuring a workpiece are provided. A first image of a first portion of a workpiece is captured, and a first location of the first portion is determined. A second image of a second portion is captured that is selected according to the first location and the location of a portion of the workpiece to be measured, and a second location of the second portion is determined. If the second image determines that the first location is correctly determined, a workpiece holding unit is moved along the original direction; otherwise, the second image replaces the first image, and the workpiece holding unit is moved along a new direction. Also, a third image of a third portion of the workpiece is further captured to replace the second image, until the third image determines that the second location is correctly determined.

### BACKGROUND

1. Technical Field

This disclosure relates to a measuring apparatus, and also relates to a workpiece measuring apparatus and a method for measuring a workpiece.

2. Description of Related Art

It is known that for an image capturing unit, the smaller its field of view (FOV) is, the more accurate an image that it captures becomes.

However, it takes time to measure a large workpiece (for example, when the diameter of the workpiece is larger than 100 mm) with a small FOV (for example, when the FOV is smaller than 30 mm) image capturing unit. In addition, it is difficult to locate such the image capturing unit at a correct position in order to measure a small portion of the workpiece accurately.

Therefore, it is an urgent issue in the art to provide a workpiece measuring apparatus and a method for measuring a workpiece that can measure a small portion of a large workpiece accurately.

### SUMMARY

The present disclosure provides a workpiece measuring apparatus. The workpiece measuring apparatus comprises a workpiece holding unit, an image capturing unit, a controlling unit and an operation unit. The workpiece holding unit configured to hold a workpiece; the image capturing unit configured to capture a first image of a first portion of the workpiece when the workpiece holding unit and the image capturing unit are spaced in a first positional relation and capture a second image of a second portion of the workpiece when the workpiece holding unit and the image capturing unit are spaced in a second positional relation; the controlling unit configured to move at least one of the workpiece holding unit and the image capturing unit and shift the workpiece holding unit and the image capturing unit from the first positional relation to the second positional relation according to the first image or shift the workpiece holding unit and the image capturing unit from the second positional relation to a third positional relation according to the second image; and the operation unit electrically connected to the image capturing unit and the controlling unit, and configured to control the image capturing unit to capture the first image and the second image and control the controlling unit to move at least one of the workpiece holding unit and the image capturing unit.

The present disclosure also provides a method for measuring a workpiece, comprising: capturing, by an image capturing unit, a first image of a first portion of a workpiece held by a workpiece holding unit when the workpiece holding unit and the image capturing unit are spaced in a first positional relation; moving at least one of the workpiece holding unit and the image capturing unit and shifting the workpiece holding unit and the image capturing unit from the first positional relation to a second positional relation according to the first image; capturing, by the image capturing unit, a second image of a second portion of the workpiece when the workpiece holding unit and the image capturing unit are in the second positional relation; and moving at least one of the workpiece holding unit and the image capturing unit and shifting the workpiece holding unit and the image capturing unit from the second positional relation to a third positional relation according to the second image.

### BRIEF DESCRIPTION OF DRAWINGS

The disclosure can be more fully understood by reading the following detailed descriptions of the embodiments, with reference made to the accompanying drawings, wherein:

FIG. 1 is a functional block diagram of a workpiece measuring apparatus of an embodiment according to the present disclosure;

FIG. 2 illustrates how the workpiece measuring apparatus measures a workpiece; and

FIG. 3 is a flow chart of a method for measuring a workpiece of an embodiment according to the present 1 disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An embodiment of the disclosure provides a workpiece measuring apparatus and a method for measuring a workpiece, in order to measure a large workpiece (for example, when the diameter of the workpiece is larger than 100 mm, but the disclosure is not limited thereto) by an image capturing unit with a small FOV (for example, when the FOV is smaller than 30 mm, but the disclosure is not limited thereto) that cannot be located at a correct position and capture an image of a small portion of the large workpiece. An embodiment of the disclosure employs a pattern matching technique and a dynamically guided feedback technique to guide a workpiece platform in order to improve the measurement accuracy.

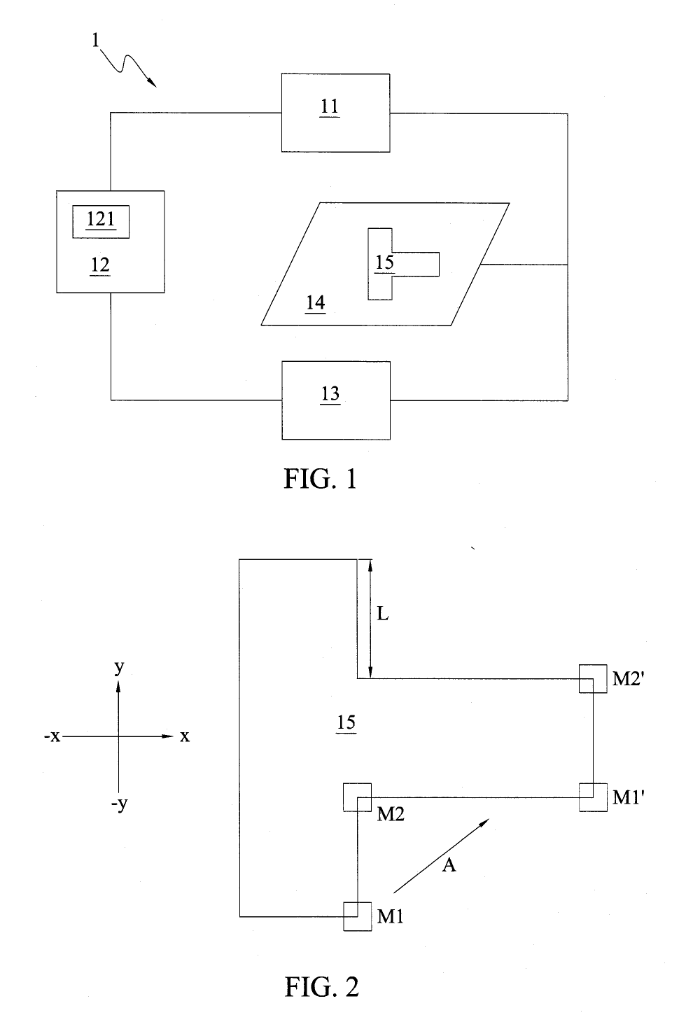

FIG. 1 is a functional block diagram of a workpiece measuring apparatus 1 of an embodiment according to the present disclosure. The workpiece measuring apparatus 1 comprises an image capturing unit 11, an operation unit 12, a controlling unit 13, and a workpiece holding unit 14.

The workpiece holding unit 14 holds a workpiece 15. In an embodiment, the workpiece holding unit 14 is a workpiece platform, on which the workpiece 15 can be placed. In another embodiment, the workpiece holding unit 14 is a workpiece holder that holds the workpiece 15.

The controlling unit 13 moves the workpiece holding unit 14 in relation to the image capturing unit 11. In an embodiment, the controlling unit 13 moves at least one of the workpiece holding unit 14 and the image capturing image 11 and shifts the workpiece holding unit 14 and the image capturing unit 11 from a first positional relation to a second positional relation. In another embodiment, the controlling unit 13 moves only the workpiece holding unit 14 from a first position to a second position such that the image capturing unit 11 and the workpiece holding unit 14 are spaced from the first positional relation to the second positional relation.

In an embodiment, the controlling unit 13 is a motor, a hydraulic press, or a gear, and moves the workpiece holding unit 14 in at least one of x-, y- and z-directions. The workpiece holding unit 14 comprises at least one movement controlling modules, each of which including a movement controller and a plurality of controlling parts.

Referring to FIG. 2, the image capturing unit 11 captures a first image M1 of a first portion of the workpiece 15 when the image capturing unit 11 and the workpiece holding unit 14 are spaced in the first positional relation, and captures a second image M2 of a second portion of the workpiece 15 when the image capturing unit 11 and the workpiece holding unit 14 are spaced in the second positional relation. In an embodiment, the controlling unit 13 moves only the workpiece holding unit 14 from the first position to the second position. The image capturing unit 11 captures the first image M1 when the workpiece holding unit 14 is at the first position, and captures the second image M2 when the workpiece holding unit 14 is at the second position.

In an embodiment, the image capturing unit 11 is an image outputting device, such as a charge-coupled device (CCD) and a complementary metal oxide semiconductor (CMOS) image sensor, and its resolution is 5K, 4K or Full HD.

As shown in FIG. 1, the operation unit 12 is electrically connected to the image capturing unit 11 and the controlling unit 13. In an embodiment, the operation unit 12 is a logical operation unit, the logical operation unit may be a computer or a field-programmable gate array (FPGA) embedded system board.

The operation unit 12 controls the image capturing unit 11 to capture the first image M1 and the second image M2.

Also, the operation unit 12 controls the controlling unit 13 to move at least one of the image capturing unit 11 and the workpiece holding unit 14′ and shift the workpiece holding unit 14 and the image capturing unit 11 from the first positional relation to the second positional relation according to the first image M1 by, for example, matching the pattern of the first image M1 with a whole image of the workpiece 15. In an embodiment, if the first image M1 is located in the lower right corner of the workpiece 15 and the length L is to be measured as shown in FIG. 2, the operation unit 12 controls the controlling unit 13 to move the workpiece holding unit 14 downward (i.e., toward the negative y direction) such that the image capturing unit 11 can be located above a portion of the workpiece 15 (e.g., the second portion; an image of which is the second image M2) that is closer to the length L than the first portion.

In an embodiment, the operation unit 12 comprises an image comparing module 121 that compares the first image M1 with the whole image of the workpiece 15, determines a first coordinate of the first image M1 with respect to the workpiece 15, and controls the controlling unit 13 to move the workpiece holding unit 14 from the first position to the second position according to the first coordinate. For example, if the first coordinate indicates that the first image M1 is located in the lower right corner, the operation unit 12 controls the controlling unit 13 to move the workpiece holding unit 14 toward the negative y direction. In an embodiment, the image comparing module 121 employs a pattern matching technique, such as the mean squared error (MSE), similarity and peak signal-to-noise ratio (PSNR), to determine the first coordinate and angle of the first image M1 with respect to the workpiece 15.

For example, as shown in FIG. 2, the image comparing module 121 compares the first image M1 with the whole image of the workpiece 15, and determines that the first portion is located in the lower right corner of the workpiece 15 and has the first coordinate (X1, Y1) with respect to an origin of the whole image of the workpiece 15 that is located at the top right corner of the whole image and a rotation angle A. If the length L is to be measured, the operation unit 12 controls the controlling unit 13 to move the workpiece holding unit 14 downward (i.e., toward the negative y direction), e.g., to move the workpiece holding unit 14 from the first position (X1′, Y1′) to the second position (X2′, Y2′) with respect to an origin of the workpiece holding unit 14 that is located initially, such that the image capturing unit 11 can be located above the second portion, which has the second image M2.

The operation unit 12 then controls the controlling unit 13 to move at least one of the image capturing unit 11 and the workpiece holding unit 14 and shifts the image capturing unit 11 and the workpiece holding unit 14 from the second positional relation to a third positional relation according to the second image M2 by, for example, matching the pattern of the second image M2 with the whole image of the workpiece 15. In an embodiment of which the first portion is indeed in the lower right corner and the second image M2 is indeed the image of the expected second portion of the workpiece 15 that is vertically upper than the first portion after the workpiece holding unit 14 moves from the first position to the second position, the operation unit 12 controls the controlling unit 13 to move the workpiece holding unit 14 further toward the negative y direction.

However, in another embodiment of which the first portion is not as expected to be in the lower right corner and the second image M2 is not as expected to be the image of the second portion that is vertically upper than the first portion (e.g., the first portion is actually in the right lower corner of the workpiece 15 and has a first image M1′, and the second image M2′ is the image of a right upper corner of the workpiece 15), the operation unit 12 controls the controlling unit 13 to move the workpiece holding unit 14 rightward (i.e., toward the positive x direction) in order for the image capturing unit 11 to be close to the length L. In other words, it is the second image M2 that determines how the controlling unit 13 moves the workpiece holding unit 14.

In an embodiment, the image comparing module 121 then compares the second image M2 with the whole image of the workpiece 15, determines a second coordinate (X2, Y2) of the second image M2 with respect to the workpiece 15, and controls the controlling unit 13 to move the workpiece holding unit 14 from the second position to a third position according to the second coordinate.

If the first portion is indeed located in the lower right corner of the workpiece 15, or a positional relation difference (X2′−X1′, Y2′−Y1′) from the first positional relation to the second positional relation proportions to a coordinate difference (X2−X1, Y2−Y1) from the first coordinate to the second coordinate (i.e., the workpiece holding unit 14 moves toward the negative y direction from the first position to the second position, and the first portion of the workpiece 15 moves upward (i.e., toward the positive y direction) from the first coordinate to the second coordinate), the second image M2 or the second coordinate (X2, Y2) must indicate that the second portion is located in the central region of the workpiece 15. Therefore, the operation unit 12 controls the controlling unit 13 to move at least one of the image capturing unit 11 and the workpiece holding unit 14 and shifts the image capturing unit 11 and the workpiece holding unit 14 from the second positional relation to a third positional relation based on the fact that the positional relation difference proportions to the coordinate difference. In an embodiment, the operation unit 12 controls the controlling unit 13 to move the workpiece holding unit 14 toward the negative y direction continuously.

If, however, the first portion is wrongly determined to be located in the lower right corner, but is located in the right lower corner of the workpiece 15 actually, or the positional relation difference (X2′−X1′, Y2′−Y1′) does not proportion to the coordinate difference (X2−X1, Y2−Y1) from the first coordinate to the second coordinate (i.e., the workpiece holding unit 14 moves toward the negative y direction from the first position to the second position, while the first portion of the workpiece 15 moves from the first coordinate to the second coordinate along an arrow A), the second image M2 or the second coordinate must indicate that the second portion is located in the right upper corner of the workpiece 15. In such a scenario, the operation unit 12 controls the controlling unit 13 to move at least one of the image capturing unit 11 and the workpiece holding unit 14 and shift the image capturing unit 11 and the workpiece holding unit 14 from the second positional relation to another third positional relation based on the fact that the positional relation difference does not proportion to the coordinate difference. In an embodiment, the operation unit 12 controls the controlling unit 13 to move the workpiece holding unit 14 toward the positive x direction.

Generally, the second image M2 is used to determine whether the location of the first portion of the workpiece 15 is correctly determined. If the second image M2 determines that the location of the first portion is correctly determined (i.e., (ΔX′, ΔY′) (i.e., (X2′−X1′, Y2′−Y1′)) proportioning to (ΔX, ΔY) (i.e., (X2−X1, Y2−Y1)), the operation unit 12 keeps controlling the controlling unit 13 to move at least one of the image capturing unit 11 and the workpiece holding unit 14 along the original direction. If the second image M2 determines that the location of the first portion is wrongly determined (i.e., (ΔX′, ΔY′) (i.e., (X2′−X1′, Y2′−Y1′)) not proportioning to (ΔX, ΔY) (i.e., (X2−X1, Y2−Y1))), the second image M2 replaces the first image M1, and the operation unit 12 controls the controlling unit 13 to move at least one of the image capturing unit 11 and the workpiece holding unit 14 such that the image capturing unit 11 and the workpiece holding unit 14 are spaced in a third positional relation, or controls the controlling unit 13 to move the workpiece holding unit 14 from the second position to a third position in a new direction. Then, a third image M3 has to be further captured to replace the second image M2.

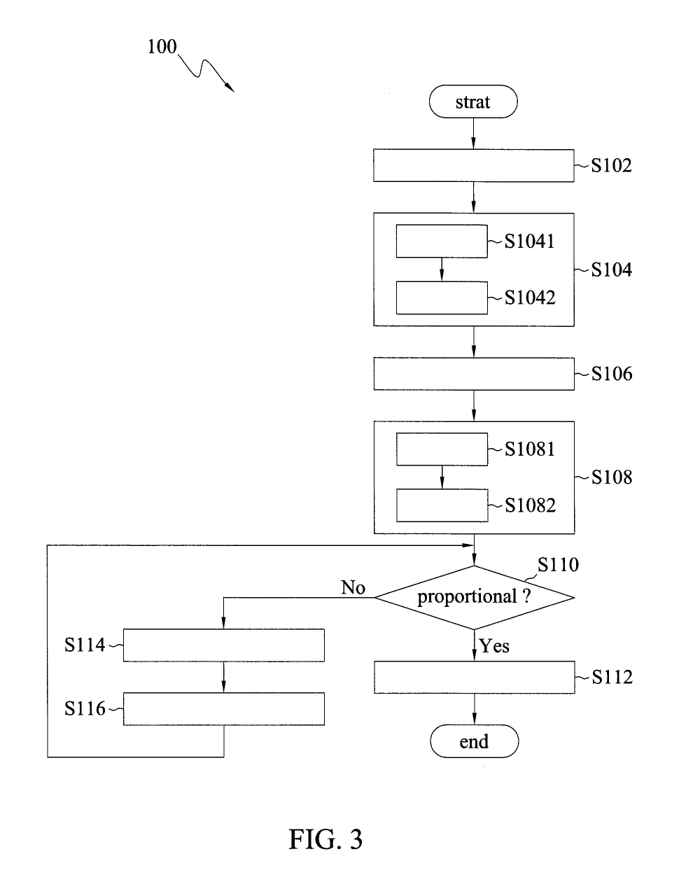

FIG. 3 is a flow chart of a method 100 for measuring a workpiece of an embodiment according to the present disclosure.

In step S102, the first image M1 of the first portion of the workpiece 15 held by the workpiece holding unit 14 is captured by the image capturing unit 11 when the image capturing unit 11 and the workpiece holding unit 14 are spaced in the first positional relation.

In step S104, at least one of the image capturing unit 11 and the workpiece holding unit 14 is moved and the image capturing unit 11 and the workpiece holding unit 14 are shifted from the first positional relation to the second positional relation according to the first image M1. For example, if the first portion is located in the lower right corner of the workpiece 15 and the length L is to be measured, the workpiece holding unit 14 should be moved toward the negative y direction; and if the first portion is located in the right lower corner of the workpiece 15 and the length L is to be measured, the workpiece holding unit 14 should be moved rightward (i.e., toward the positive x direction) and downward.

In step S106, the second image M2 of the second portion of the workpiece 15 is captured by the image capturing unit 11 when the image capturing unit 11 and the workpiece holding unit 14 are in the second positional relation.

In step S108, at least one of the image capturing unit 11 and the workpiece holding unit 14 is moved and the image capturing unit 11 and the workpiece holding unit 14 are shifted from the second positional relation to the third positional relation according to the second image M2. The second image M2 determines whether the location of the first portion is correctly or wrongly determined, and whether the image capturing unit 11 and/or the workpiece holding unit 14 should be moved along the original direction or a new direction.

Step 104 comprises step S1041 and step S1042, of which the first coordinate of the first image M1 with respect to the workpiece 15 is calculated in step S1041 and at least one of the image capturing unit 11 and the workpiece holding unit 14 is moved and the image capturing unit 11 and the workpiece holding unit 14 are shifted from the first positional relation to the second positional relation according to the first coordinate in step S1042.

Step S108 comprises step S1081 and step S1082, of which the second coordinate of the second image M2 with respect to the workpiece 15 is calculated in step S1081 and at least one of the image capturing unit 11 and the workpiece holding unit 14 is moved and the image capturing unit 11 and the workpiece holding unit 14 are shifted from the second positional relation to the third positional relation according to a relation between a positional relation difference from the first positional relation to the second positional relation and a coordinate difference from the first coordinate to the second coordinate in step S1082.

In step S110, it is determined whether the relation indicates the positional relation difference proportioning to the coordinate difference, or the positional relation difference being free from proportioning to the coordinate difference. If the relation indicates the positional relation difference proportioning to the coordinate difference, at least one of the image capturing unit 11 and the workpiece holding unit 14 are shifted from the third positional relation to a fourth positional relation according to the relation, as described in step S112. In such a scenario, at least one of the image capturing unit 11 and the workpiece holding unit 14 is moved in the original direction, until the image capturing unit 11 is disposed above the length L that is to be measured. If the relation indicates the positional relation difference being free from proportioning to the coordinate difference, the third image M3 of the workpiece 15 is captured when the image capturing unit 11 and the workpiece holding unit 14 are spaced in the third positional relation. Accordingly, the second image M2 replaces the first image M1, and the third image M3 replaces the second image M2, as described in step S114. At least one of the image capturing unit 11 and the workpiece holding unit 14 is moved and the image capturing unit 11 and the workpiece holding unit 14 are shifted from the third positional relation to a fourth positional relation according to the third image M3, until the relation indicates that the positional relation difference proportions to the coordinate difference, as described in step S116.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A workpiece measuring apparatus, comprising:
a workpiece holding unit configured to hold a workpiece;
an image capturing unit configured to capture a first image of a first portion of the workpiece when the workpiece holding unit and the image capturing unit are spaced in a first positional relation and capture a second image of a second portion of the workpiece when the workpiece holding unit and the image capturing unit are spaced in a second positional relation;
a controlling unit configured to move at least one of the workpiece holding unit and the image capturing unit and shift the workpiece holding unit and the image capturing unit from the first positional relation to the second positional relation according to the first image or shift the workpiece holding unit and the image capturing unit from the second positional relation to a third positional relation according to the second image; and
an operation unit electrically connected to the image capturing unit and the controlling unit, and configured to control the image capturing unit to capture the first image and the second image and control the controlling unit to move at least one of the workpiece holding unit and the image capturing unit.

2. The workpiece measuring apparatus of claim 1, wherein the operation unit is configured to calculate a first coordinate of the first image and a second coordinate of the second image with respect to the workpiece.

3. The workpiece measuring apparatus of claim 2, wherein the operation unit is further configured to control the controlling unit to move at least one of the workpiece holding unit and the image capturing unit and shift the workpiece holding unit and the image capturing unit from the first positional relation to the second positional relation according to the first coordinate or shift the workpiece holding unit and the image capturing unit from the second positional relation to the third positional relation according to a relation between a positional relation difference from the first positional relation to the second positional relation and a coordinate difference from the first coordinate to the second coordinate.

4. The workpiece measuring apparatus of claim 3, wherein the relation indicates the positional relation difference proportioning to the coordinate difference, and the operation unit further controls the controlling unit to move at least one of the workpiece holding unit and the image capturing unit and shift the workpiece holding unit and the image capturing unit from the third positional relation to a fourth positional relation according to the relation.

5. The workpiece measuring apparatus of claim 3, wherein the relation indicates the positional relation difference being free from proportioning to the coordinate difference, and the image capturing unit captures a third image of a third portion of the workpiece.

6. The workpiece measuring apparatus of claim 5, wherein the operation unit further controls the controlling unit to move at least one of the workpiece holding unit and the image capturing unit and shift the workpiece holding unit and the image capturing unit from the third positional relation to a fourth positional relation according to the third image.

7. The workpiece measuring apparatus of claim 2, wherein the operation unit comprises an image comparing module configured to compare the first image with a whole image of the workpiece and determine the first coordinate of the first image with respect to the workpiece.

8. The workpiece measuring apparatus of claim 8, wherein the image comparing module determines the first coordinate of the first image by at least one of mean squared error (MSE), similarity, and peak signal-to-noise ratio (PSNR).

9. The workpiece measuring apparatus of claim 1, wherein the operation unit is a logical operation unit.

10. The workpiece measuring apparatus of claim 9, wherein the logical operation unit is a computer or a field-programmable gate array (FPGA) embedded system board.

11. The workpiece measuring apparatus of claim 1, wherein the controlling unit moves the workpiece holding unit or the image capturing unit in at least one of x-, y- and z-directions.

12. The workpiece measuring apparatus of claim 1, wherein the workpiece holding unit comprises at least one movement controlling module, and each of the at least one movement controlling module includes a movement controller and a plurality of controlling parts.

13. A method for measuring a workpiece, comprising:
capturing, by an image capturing unit, a first image of a first portion of a workpiece held by a workpiece holding unit when the workpiece holding unit and the image capturing unit are spaced in a first positional relation;
moving at least one of the workpiece holding unit and the image capturing unit and shifting the workpiece holding unit and the image capturing unit from the first positional relation to a second positional relation according to the first image;
capturing, by the image capturing unit, a second image of a second portion of the workpiece when the workpiece holding unit and the image capturing unit are in the second positional relation; and
moving at least one of the workpiece holding unit and the image capturing unit and shifting the workpiece holding unit and the image capturing unit from the second positional relation to a third positional relation according to the second image.

14. The method of claim 13, wherein moving at least one of the workpiece holding unit and the image capturing unit and shifting the workpiece holding unit and the image capturing unit from the first positional relation to the second positional relation according to the first image comprises calculating a first coordinate of the first image with respect to the workpiece.

15. The method of claim 14, wherein moving at least one of the workpiece holding unit and the image capturing unit and shifting the workpiece holding unit and the image capturing unit from the first positional relation to the second positional relation according to the first image further comprises moving at least one of the workpiece holding unit and the image capturing unit and shifting the workpiece holding unit and the image capturing unit from the first positional relation to the second positional relation according to the first coordinate.

16. The method of claim 13, wherein moving at least one of the workpiece holding unit and the image capturing unit and shifting the workpiece holding unit and the image capturing unit from the second positional relation to the third positional relation according to the second image comprises calculating a second coordinate of the second image with respect to the workpiece.

17. The method of claim 16, wherein moving at least one of the workpiece holding unit and the image capturing unit and shifting the workpiece holding unit and the image capturing unit from the second positional relation to the third positional relation according to the second image further comprises moving at least one of the workpiece holding unit and the image capturing unit and shifting the workpiece holding unit and the image capturing unit from the second positional relation to the third positional relation according to a relation between a positional relation difference from the first positional relation to the second positional relation and a coordinate difference from the first coordinate to the second coordinate.

18. The method of claim 17, wherein the relation indicates the positional relation difference proportioning to the coordinate difference, and the method further comprises moving at least one of the workpiece holding unit and the image capturing unit and shifting the workpiece holding unit and the image capturing unit from the third positional relation to a fourth positional relation according to the relation.

19. The method of claim 17, wherein the relation indicates the positional relation difference being free from proportioning to the coordinate difference, and the method further comprises capturing a third image of a third portion of the workpiece.

20. The method of claim 19, further comprising moving at least one of the workpiece holding unit and the image capturing unit and shifting the workpiece holding unit and the image capturing unit from the third positional relation to a fourth positional relation according to the third image.
